(19) United States
(12) Patent Application Publication
(10) Pub. No.: US 2023/0300858 A1
(43) Pub. Date: Sep. 21, 2023

(54) A METHOD AND AN APPARATUS FOR UE COORDINATION

(71) Applicant: Samsung Electronics Co., Ltd., Gyeonggi-do (KR)

(72) Inventors: Miao ZHOU, Beijing (CN); Feifei SUN, Beijing (CN); Min WU, Beijing (CN)

(21) Appl. No.: 18/019,616

(22) PCT Filed: Aug. 4, 2021
(86) PCT No.: PCT/KR2021/010277

§ 371 Date: Feb. 3, 2023

(30) Foreign Application Priority Data
Aug. 5, 2020 (CN) 202010779500.5

(51) Int. Cl. H04W 72/25; H04W 72/02; H04W 72/1263

(52) U.S. Cl. CPC H04W 72/25; H04W 72/02; H04W 72/1263

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The invention provides a method performed by a first user equipment (UE) in a wireless communication, the method comprising: identifying trigger for generating first information related to sidelink communication; in response to the trigger, generating the first information; determining resource locations for transmitting the first information; and transmitting first signaling to a second UE based on the resource locations, wherein the first signaling includes the first information.

### TECHNICAL FIELD

The application relates to a technical field of wireless communication, more particularly, to a method for transmitting sidelink data and corresponding sidelink feedback messages in Sidelink (SL) communication in a fifth generation new radio access technology (5G NR) system.

### BACKGROUND ART

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In Long Term Evolution (LTE) technology, sidelink communication includes two main mechanisms: direct communication of Device to Device (D2D) and vehicle-to-everything communication (Vehicle to Vehicle/Infrastructure/Pedestrian/Network, V2X for short), which is designed based on D2D technology, and is superior to D2D in data rate, latency, reliability and link capacity and the like, and is a most representative sidelink communication technology in LTE technology. In a 5G system, sidelink communication mainly includes vehicle-to-everything (V2X) communication.

There are several sidelink physical channels defined in an NR V2X system, including Physical Sidelink Control Channel (PSCCH), Physical Sidelink Shared Channel (PSSCH) and Physical Sidelink Feedback Channel (PSFCH). PSSCH is used to carry data, PSCCH is used to carry Sidelink Control Information (SCI), in which information such as locations of time-frequency domain resources of the associated PSSCH transmission, modulation and coding mode, reception destination ID targeted by the PSSCH is indicated, and PSFCH is used to carry HARQ-ACK information corresponding to the data.

In the NR V2X system, at present, a slot in the 5G system is used as the minimum unit for resource allocation in time-domain, and a sub-channel is defined as the minimum unit for resource allocation in frequency-domain. A sub-channel is configured as several RBs in frequency-domain, and a sub-channel may include resources corresponding to at least one of PSCCH, PSSCH and PSFCH.

From the perspective of resource allocation, a 5G sidelink communication system includes two modes: a resource allocation mode based on base station (BS) scheduling and a resource allocation mode based on UE autonomous selection. In the 5G V2X system, the resource allocation mode based on BS scheduling and the resource allocation mode based on UE autonomous selection are called Mode 1 and Mode 2, respectively.

In Mode 1, the method for a BS to schedule resources for a sidelink UE is to transmit a sidelink grant to the sidelink UE, and indicate several or periodic sidelink resources for the sidelink UE in the sidelink grant. Sidelink grant includes dynamic grant and configured grant, in which dynamic grant is indicated by DCI, and configured grant further includes Type 1 configured grant and Type 2 configured grant. Type 1 configured grant is indicated by Radio Resource Control (RRC) signaling, and Type 2 configured grant is indicated by RRC signaling and is activated/deactivated by DCI.

In Mode 2, the method for a sidelink UE to select resources autonomously is to determine according to an time range expected for transmitting the sidelink transmission, perform channel sensing within a specific time window before expected for transmitting the sidelink transmission, exclude sidelink resources that have been reserved by other sidelink UEs according to the result of channel sensing, and randomly select among the remaining sidelink resources that have not been excluded.

### DISCLOSURE OF INVENTION

### Solution to Problem

The present disclosure has been made in view of the above problems.

According to an aspect of the present disclosure, there is provided a communication method performed by a first user equipment (UE), the method including: generating first information; and transmitting first signaling to the first UE, wherein the first signaling includes the first information.

Furthermore, a method according to one aspect of the present disclosure, wherein the first information includes one or more candidate sidelink resources indicated by at least one of the following: time-frequency locations of the one or more candidate sidelink resources; and bitmaps corresponding to the one or more candidate sidelink resources.

Furthermore, a method according to one aspect of the present disclosure, wherein whether the first information is carried in sidelink control information (SCI) included in physical layer signaling is explicitly or implicitly indicated by the SCI, wherein being explicitly indicated by the SCI includes being indicated by additional fields, and being implicitly indicated by the SCI includes being indicated by existing SCI formats, and/or new SCI formats, and/or a specific value of a field or a specific combination of values of multiple fields in the SCI.

Furthermore, a method according to one aspect of the present disclosure, wherein a number of the first signaling is M, and the value of M is greater than or equal to 1.

Furthermore, a method according to one aspect of the present disclosure, wherein the value of the number M of the first signaling is determined based on priority, and/or latency requirement, and/or size of the first information.

Furthermore, a method according to one aspect of the present disclosure, wherein resource locations for transmitting the first information are determined based on at least one of the following: channel sensing; resources configured or scheduled by a third node, which is any one of a base station, a higher layer of the first UE, and any UE except the first UE; and trigger signaling or trigger condition, which is used to trigger the first UE to generate and transmit the first information.

Furthermore, a method according to one aspect of the present disclosure, wherein the resources configured or scheduled by the third node are determined based on at least one of the following: resource pool-specific parameters related to the first information; parameters related to the first information determined based on identities of a transmitter UE and/or a receiver UE; parameters related to the first information determined based on a priority; and parameters related to the first information determined based on geographic location information.

Furthermore, a method according to one aspect of the present disclosure, wherein in the case that the first UE fails to transmit the first information at the resource locations for transmitting the first information, the method further includes at least one of the following: reselecting the resource locations for transmitting the first information; dropping transmission of the first information at the resource locations; and postponing the transmission of the first information at the resource locations.

Furthermore, a method according to one aspect of the present disclosure, the method further includes: receiving second signaling fed back by the second UE, and obtaining second information from the second signaling, wherein the second information is used to determine whether the second UE successfully receives the first information and/or whether the second UE is able to use the first information.

Furthermore, a method according to one aspect of the present disclosure, wherein in the case that it is determined that the second UE fails to receive the first information successfully and/or the second UE is not able use the first information, the method further includes at least one of the following: regenerating the first information; and transmitting first signaling containing the first information to the second UE again.

According to another aspect of the present disclosure, there is provided a communication method performed by a second user equipment (UE), the method including: receiving first signaling, and obtaining first information from the first signaling.

A method according to another aspect of the present disclosure, the obtaining the first information includes at least one of the following: monitoring a resource pool and detecting the first information that possibly exists in the resource pool; and in the case that it is determined that the first information is obtained from a first UE, obtaining resource locations for the first UE to transmit the first information, and detecting the first information that possibly exists from the first UE at the resource locations.

A method according to another aspect of the present disclosure, the obtaining the first information includes at least one of the following: obtaining the first information on periodic specific resources in a resource pool; and when the second UE needs to transmit a sidelink channel, triggering to monitor specific resources in the resource pool to obtain the first information, wherein the periodic specific resources in the resource pool include a complete resource pool and/or a subset of the resource pool.

A method according to another aspect of the present disclosure, when the second UE needs to transmit the sidelink channel, the triggering to monitor specific resources in the resource pool to obtain the first information includes at least one of the following: obtaining the first information within a time range of channel sensing; and obtaining the first information within a time range in which resource reselection can be performed.

A method according to another aspect of the present disclosure, when the second UE needs to transmit the sidelink channel, the obtaining the first information includes at least one of the following: after obtaining the first information, keep monitoring the resource pool until the sidelink channel is transmitted; and after obtaining the first information, keep monitoring the resource pool until the latest time point that resource reselection is able to be triggered.

A method according to another aspect of the present disclosure, further includes at least one of the following: determining whether the first information is valid; and determining whether one or more sidelink resources indicated in the first information are available.

A method according to another aspect of the present disclosure, wherein in the case that it is determined that the first information is invalid and/or the sidelink resource set including one or more sidelink resources indicated in the first information is unavailable, the method further includes at least one of the following: triggering resource reselection; and re-obtaining the first information.

A method according to another aspect of the present disclosure, wherein the determining whether one or more candidate sidelink resources indicated in the first information are available includes: determining whether each of one or more candidate sidelink resources indicated in the first information is available; excluding unavailable sidelink resources among the one or more candidate sidelink resources; determining whether a number of remaining available sidelink resources is in a specific interval, wherein, if the number is in the specific interval, determining that a candidate sidelink resource set including the one or more candidate sidelink resources is available; and if the number is not in the specific interval, determining that the candidate sidelink resource set including the one or more candidate sidelink resources is unavailable.

A method according to another aspect of the present disclosure, the method further includes: feeding back second signaling to a first UE, wherein the second signaling contains second information, wherein the second information is used to determine whether the second UE successfully receives the first information and/or whether the second UE is able to use the first information.

A method according to another aspect of the present disclosure, wherein the second signaling includes at least one of the following: HARQ-ACK feedback, dedicated physical layer acknowledgement signaling, and dedicated higher layer acknowledgement signaling.

A method according to another aspect of the present disclosure, if the sidelink resource set including one or more candidate sidelink resources indicated in the first information is unavailable, and/or if one or more candidate sidelink resources indicated in the first information are unavailable, and/or if one or more sidelink resources indicated in the first information are occupied by other higher-priority services, the method further includes: requesting the first UE to update the first information.

A method according to another aspect of the present disclosure, wherein the requesting the first UE to update the first information includes: transmitting third signaling to the first UE.

A method according to another aspect of the present disclosure, wherein the third signaling includes at least one of the following: acknowledgement signaling indicating that the second UE fails to receive the first information; acknowledgement signaling indicating that the second UE is not able to use the first information; and dedicated update request signaling.

According to another aspect of the present disclosure, there is provided a first user equipment (UE), which includes a processor and a memory, wherein the memory stores a computer program, and the processor executes the computer program to realize the above method.

According to another aspect of the present disclosure, there is provided a second user equipment (UE), which includes a processor and a memory, wherein the memory stores a computer program, and the processor executes the computer program to realize the above method.

According to another aspect of the present disclosure, there is provided a method performed by a first user equipment (UE) in a wireless communication, the method comprising: identifying trigger for generating first information related to sidelink communication; in response to the trigger, generating the first information; determining resource locations for transmitting the first information and transmitting first signaling to a second UE based on the resource locations, wherein the first signaling includes the first information.

A method according to another aspect of the present disclosure, wherein whether the first information is carried in sidelink control information (SCI) included in physical layer signaling is explicitly or implicitly indicated by the SCI, wherein being explicitly indicated by the SCI includes being indicated by additional fields, and being implicitly indicated by the SCI includes being indicated by existing SCI formats, and/or new SCI formats, and/or a specific value of a field or a specific combination of values of multiple fields in the SCI, wherein a number of the first signaling is M, and the value of M is greater than or equal to 1, wherein the value of M is determined based on at least one of priority, signaling capacity, latency requirement, and size of the first information.

A method according to another aspect of the present disclosure, wherein the resource locations are determined based on at least one of the following: channel sensing; resources configured or scheduled by a third node, which is any one of a base station, a higher layer of the first UE, and any UE except the first UE; and trigger signaling or trigger condition, which is used to trigger the first UE to generate and transmit the first information.

A method according to another aspect of the present disclosure, wherein the resources configured or scheduled by the third node are determined based on at least one of the following: resource pool-specific parameters related to the first information; parameters related to the first information determined based on identities of a transmitter UE and/or a receiver UE; parameters related to the first information determined based on a priority; and parameters related to the first information determined based on geographic location information.

A method according to another aspect of the present disclosure, wherein in the case that the first UE fails to transmit the first information at the resource locations for transmitting the first information, the method further includes at least one of the following: reselecting the resource locations for transmitting the first information; dropping transmission of the first information at the resource locations; and postponing the transmission of the first information at the resource locations.

A method according to another aspect of the present disclosure, the method further comprising: receiving second signaling fed back by the second UE, and
obtaining second information from the second signaling, wherein the second information is used to determine whether the second UE successfully receives the first information and/or whether the second UE is able to use the first information.

According to another aspect of the present disclosure, there is provided a method performed by a second user equipment (UE) in a wireless communication, the method comprising: receiving, from first UE, first signaling, and obtaining first information related to sidelink communication from the first signaling, feeding back second signaling to the first UE, wherein the second signaling comprises second information, wherein the second information is used to determine at least one of whether the second UE successfully receives the first information and whether the second UE is able to use the first information.

A method according to another aspect of the present disclosure, wherein the obtaining the first information comprises at least one of the following: monitoring a resource pool and detecting the first information that possibly exists in the resource pool; and in the case that it is determined that the first information is obtained from a first UE, obtaining resource locations for the first UE to transmit the first information, and detecting the first information that possibly exists from the first UE at the resource locations.

A method according to another aspect of the present disclosure, wherein the obtaining the first information comprises at least one of the following: obtaining the first information on periodic specific resources in a resource pool; and in case that the second UE needs to transmit a sidelink channel, triggering to monitor specific resources in the resource pool to obtain the first information, wherein the periodic specific resources in the resource pool include a complete resource pool and/or a subset of the resource pool, and wherein in case that the second UE needs to transmit the sidelink channel, triggering to monitor specific resources in the resource pool to obtain the first information comprises at least one of the following: obtaining the first information within a time range of channel sensing; and
obtaining the first information within a time range in which resource reselection can be performed.

A method according to another aspect of the present disclosure, wherein in case that the second UE needs to transmit the sidelink channel, the obtaining the first information includes at least one of the following: after obtaining the first information, keep monitoring the resource pool until the sidelink channel is transmitted; and after obtaining the first information, keep monitoring the resource pool until the latest time point that resource reselection is able to be triggered.

A method according to another aspect of the present disclosure, the method further comprising at least one of the following: determining whether the first information is valid; and determining whether a sidelink resource set including one or more sidelink resources indicated in the first information is available.

A method according to another aspect of the present disclosure, wherein in the case that it is determined that the first information is invalid and/or the sidelink resource set including one or more sidelink resources indicated in the first information is unavailable, the method further comprises at least one of the following: triggering resource reselection; and re-obtaining the first information, or wherein determining whether the sidelink resource set including the one or more candidate sidelink resources indicated in the first information is available comprises: determining whether each of the one or more candidate sidelink resources indicated in the first information is available; excluding unavailable sidelink resources among the one or more candidate sidelink resources; determining whether a number of remaining available sidelink resources is in a specific interval, wherein, in case that the number is in the specific interval, determining that a candidate sidelink resource set including the one or more candidate sidelink resources is available; and in case that the number is not in the specific interval, determining that the candidate sidelink resource set including the one or more candidate sidelink resources is unavailable.

A method according to another aspect of the present disclosure, in case that the sidelink resource set including one or more candidate sidelink resources indicated in the first information is unavailable, or in case that one or more candidate sidelink resources indicated in the first information are unavailable, or in case that one or more sidelink resources indicated in the first information are occupied by other higher-priority services, the method further comprises: requesting the first UE to update the first information, wherein requesting the first UE to update the first information comprises: transmitting third signaling to the first UE, wherein the third signaling includes at least one of the following: signaling indicating that the second UE fails to receive the first information; signaling indicating that the second UE is not able to use the first information; and signaling for update request.

### BRIEF DESCRIPTION OF DRAWINGS

The above and other objects, features and advantages of the present disclosure will become more apparent by describing embodiments of the present disclosure in more detail with reference to the accompanying drawings. The accompanying drawings are intended to provide a further understanding of the embodiments of the present disclosure and constitute a part of the specification, and together with the embodiments of the present disclosure, serve to explain the present disclosure, and do not constitute a limitation on the present disclosure. In the drawings, the same reference numerals generally represent the same parts or stages.

FIG. 1 illustrates a schematic diagram of a wireless network;

FIGS. 2a and 2b illustrate schematic diagrams of wireless transmission and reception paths in a wireless network;

FIG. 3a illustrates a schematic diagram of a user equipment (UE);

FIG. 3b illustrates a schematic diagram of a base station (gNB);

FIG. 4 illustrates a flowchart of a method performed by a first UE;

FIG. 5 illustrates a flowchart of a method performed by a second UE; and

FIG. 6 illustrates an example of the hidden node problem.

### MODE FOR THE INVENTION

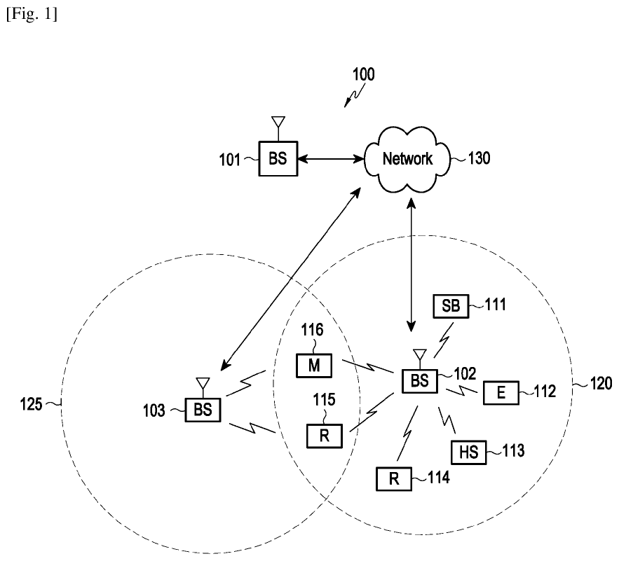

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

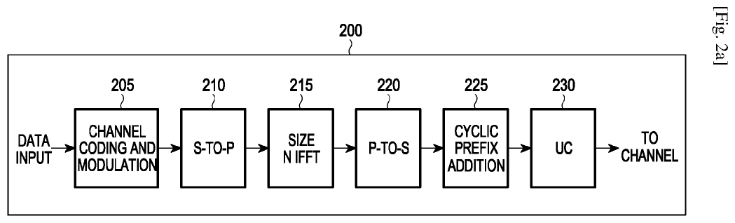

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

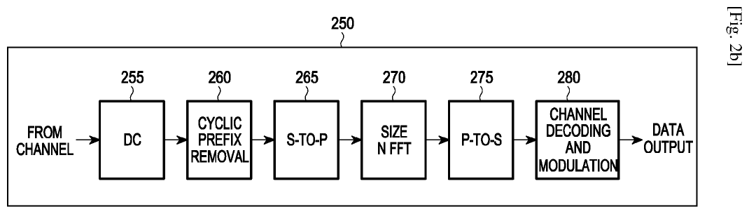

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

As will be understood by those skilled in the art, the singular forms “a”, “an”, “said” and “the” used herein may also include plural forms unless expressly stated. It should be further understood that the phrase “including” used in the specification of the present invention means the presence of stated features, integers, steps, operations, elements and/or components, but does not exclude the presence or addition of one or more other features, integers, steps, operations, elements, components and/or groups thereof. It should be understood that when we say that an element is “connected” or “coupled” to another element, it may be directly connected or coupled to the another element, or there may be intermediate elements. In addition, “connected” or “coupled” as used herein may include wireless connection or wireless coupling. As used herein, the phrase “and/or” includes all or any unit and all combinations of one or more associated listed items.

It can be understood by those skilled in the art that unless otherwise defined, all terms (including technical terms and scientific terms) used herein have the same meanings as those generally understood by those skilled in the art to which the present invention belongs. It should also be understood that terms such as those defined in a general dictionary should be understood to have meanings consistent with those in the context of the prior art, and will not be interpreted in idealized or overly formal meanings unless specifically defined as here.

As can be understood by those skilled in the art, “user equipment (UE)”, “terminal” and “terminal equipment” used herein include not only device of a wireless signal receiver which has no transmitting capability, but also device of a receiving and transmitting hardware which can perform bidirectional communication on a bidirectional communication link. In the embodiments of this application, when the sidelink communication system is a V2X system, “user equipment (UE)”, “terminal” and “terminal equipment” may be of various types such as vehicles, infrastructure and pedestrians. Such devices may include: a cellular or other communication device with a single-line display or a multi-line display or a cellular or other communication device without a multi-line display; a PCS (Personal Communications Service), which may combine capabilities of voice processing, data processing, fax and/or data communication; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop or other device having and/or including a radio frequency receiver. As used herein, “terminal” and “terminal equipment” can be portable, transportable, installed in vehicles (aviation, sea transportation and/or land), or suitable and/or configured to run locally, and/or run at any other location on the earth and/or space in a distributed form. As used herein, “user equipment (UE)”, “terminal” and “terminal equipment” may also be a communication terminal, a surfing terminal, or a music/video playing terminal, such as a PDA, an MID (Mobile Internet Device) and/or a mobile phone with music/video playing functions, a smart TV, a set-top box and other devices.

The slot in the embodiments of this application may be either a physical subframe or slot, or a logical subframe or slot. Specifically, a logical subframe or slot is a subframe or slot corresponding to a resource pool of sidelink communication. For example, in the V2X system, the resource pool is defined by a repeated bitmap, which is mapped to a specific slot set, which may be all slots or all other slots except some specific slots (such as slots for transmitting MIB/SIB). Slots indicated as “1” in the bitmap may be used for V2X transmission and belong to the slots corresponding to V2X resource pool, and slots indicated as “0” cannot be used for V2X transmission and do not belong to the slots corresponding to V2X resource pool.

The difference between physical subframes or slots and logical subframes or slots is explained by a typical application scenario: when calculating the time-domain gap between two specific channels/messages (for example, PSSCH carrying sidelink data and PSFCH carrying corresponding feedback information), it is assumed that the gap is N slots. If physical subframes or slots are calculated, the N slots correspond to the absolute time length of N*x milliseconds in the time-domain, where x is the time length of a physical slot (subframe) under the Numerology of this scenario, of which the unit is millisecond; otherwise, if logical subframes or slots are calculated, taking the sidelink resource pool defined by the bitmap as an example, the gap of the N slots corresponds to N slots indicated as “1” in the bitmap, and the absolute time length of the gap varies with the specific configuration of the sidelink communication resource pool, without a fixed value.

In the embodiments of the present application, a slot may be a complete slot or several OFDM symbols corresponding to sidelink communication in a slot. For example, when the sidelink communication is configured to be performed on the X1˜X2 OFDM symbols in each slot, a slot in the following embodiments refers to the X1˜X2 OFDM symbols in a slot. For another example, when the sidelink communication is configured to be transmitted in a Mini-Slot, a slot in the following embodiments refers to a mini-slot defined or configured in the sidelink system, and not the slot in the NR system. For another example, when the sidelink communication is configured as symbol-level transmission, a slot in the embodiments may be replaced with an OFDM symbol, or may be replaced with N OFDM symbols with a time-domain granularity as symbol-level transmission.

In the embodiments of this application, information configured by the BS, information indicated by signaling, information configured by the higher layer, and the pre-configured information may be a set of configuration information or multiple sets of configuration information. When the information contains multiple sets of configuration information, the UE selects one set of configuration information from the multiple sets of configuration information for use according to predefined conditions. When the information is a set of configuration information, the set of configuration information may contain multiple subsets, and the UE selects one subset from the multiple subsets for use according to predefined conditions.

In the embodiments of this application, some of the technical solutions provided are specifically described based on a V2X system, but their application scenarios should not be limited to the V2X system in sidelink communication, but may also be applied to other sidelink transmission systems. For example, the design based on V2X subchannel in the following embodiments may also be used for D2D subchannels or other subchannels for sidelink transmission. The V2X resource pool in the following embodiments may also be replaced by a D2D resource pool in other sidelink transmission systems such as D2D.

In the embodiments of this application, below a threshold may also be replaced by at least one of above the threshold, below or equal to the threshold, and above or equal to the threshold; similarly, above a threshold may be replaced by at least one of below the threshold, below or equal to the threshold, and above or equal to the threshold. Among them, related expressions may be replaced by other expressions with the same or similar meanings, for example, “above” may also be expressed as “exceeding”.

In the embodiments of this application, a UE used for transmitting a physical sidelink data channel is called a transmitter UE and marked as a TX UE; and a UE used for receiving a physical sidelink data channel is called a receiver UE and is marked as a RX UE.

In the embodiments of this application, when the sidelink communication system is a V2X system, the terminal or UE may be various types of terminals or UE such as Vehicle, Infrastructure, Pedestrian, etc.

In the prior art, when using Mode 2, the UE may only determine which resources have been reserved by other UEs thus not suitable for the transmission of this UE according to the successfully received content of SCI transmitted by other sidelink UEs. However, there is some possibility that the UE may miss the SCI transmitted by other sidelink UEs, so that resources reserved in the missed SCI may not be excluded, which affects the reliability of the prior art. In addition, there is a problem of hidden nodes in sidelink communication. However, in the prior art, the transmitter UE can only perceive the interference of other sidelink UEs in the communication range of the transmitter UE itself, but can not perceive the interference of other sidelink UEs in the communication range of the receiver UE, so that the problem of hidden nodes cannot be solved, which may lead to conflicts at the receiver UE.

When Mode 1 is used, the BS cannot perceive the channel condition at the transmitter UE, so it cannot avoid data or interference from other sidelink UEs that the transmitter UE may receive when scheduling transmission resources for the transmitter UE, thus, it may schedule resources with relatively poor channel quality or conflicting with other sidelink reception for the transmitter UE.

In addition, in the prior art, grouping of UEs is supported. If there are UEs managed as a group, the UEs may further optimize the utilization efficiency of sidelink resources by allocating and coordinating the transmission resources of other sidelink UEs in the group.

In the prior art, the sidelink UE needs to keep monitoring on the configured whole resource pool, which will cause large power consumption. In addition, in the prior art, channel sensing is also on the premise that UE monitors and caches the resource pool, so channel sensing requires certain monitoring and caching ability of the UE. UEs that are sensitive to power consumption and may have weak caching capacity will be introduced in the future version, which are not suitable for the existing mechanism. After introducing a UE assistance mechanism, the UE may replace the channel sensing with the received first information in part, thus reducing the power consumption of monitoring the resource pool accordingly.

Based on the above problems, this application is proposed. In order to make the purposes, technical schemes and advantages of this application clearer, implementations of this application will be further described in detail with reference to the accompanying drawings.

### The First Embodiment

The first embodiment describes a method for UE coordination.

When performing the UE coordination method, a UE initiating coordination is hereinafter referred to as the first UE, and the UE cooperating with the coordination is hereinafter referred to as the second UE. It should be noted that this distinction is only for convenience of description, and is not a limitation of UE functions, that is, any UE may initiate coordination as the first UE, and may also cooperate with the coordination as the second UE.

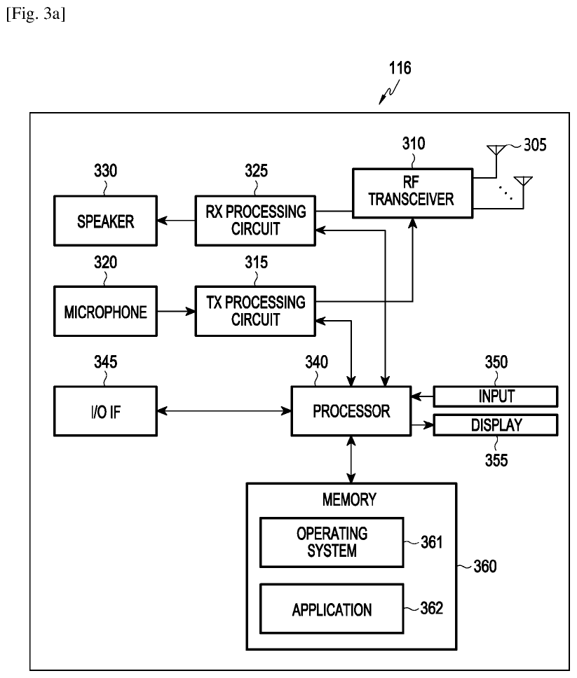

FIG. 4 is a flowchart of a method performed by a first UE in the first embodiment.

As shown in FIG. 4, in the first embodiment, the first UE performs the following steps to coordinate with the second UE:

Step 401: generating first information; and

Step 402: transmitting first signaling to a second UE, where the first signaling includes the first information.

In the first embodiment, optionally, the first UE further performs the following steps to coordinate with the second UE:

Step 403: receiving second signaling fed back by the second UE; and

Step 404: obtaining second information from the second signaling, where the second information is used to determine whether the second UE successfully receives the first information and/or whether the second UE is able to use the first information.

In an example of the first embodiment, the first information at least includes one or more candidate sidelink resources indicated by at least one of the following: time-frequency locations of the one or more candidate sidelink resources, and bitmaps corresponding to the one or more candidate sidelink resources.

In another example of the first embodiment, the first information is carried in at least one of the following: radio resource control (RRC) signaling, medium access control (MAC) signaling, and physical layer signaling. The physical layer signaling includes sidelink control information (SCI), and the SCI further includes a 1st stage SCI and/or a 2nd stage SCI. Optionally, whether the first information is carried in sidelink control information (SCI) is explicitly or implicitly indicated by the SCI. Being explicitly indicated by the SCI may be being indicated by additional fields, while being implicitly indicated by the SCI may be being indicated by existing SCI formats, and/or new SCI formats, and/or a specific combination of values of some fields in the SCI. Optionally, whether the first information is carried in higher layer signaling is explicitly or implicitly indicated by the SCI, where the higher layer signaling includes higher layer signaling carried on PSSCH associated with the SCI, and the specific indicating method is similar to the above.

In another example of the first embodiment, the first information is carried in M signaling, and M is greater than or equal to 1. Optionally, the value of the number M of the signaling is determined based on the priority, and/or the latency requirement, and/or the size of the first information. Optionally, the value of the number M of the signaling is configured by the BS or the higher layer, or is pre-configured, and the configuration may be priority-specific, for example, the BS configures the value of M for each priority or QoS or physical layer priority respectively.

In another example of the first embodiment, the first UE generating and transmitting the first information to the second UE includes the first UE periodically generating and transmitting the first information to the second UE, and/or the first UE being triggered to generate and transmit the first information to the second UE when certain triggering conditions are met.

In another example of the first embodiment, resource locations for the first UE to transmit the first information to the second UE are determined based on at least one of the following: determining the resource locations for transmitting the first information based on channel sensing; determining the resource locations for transmitting the first information based on resources configured or scheduled by the BS/a higher layer of the first UE/other UE; and if the first UE is triggered to generate and transmit the first information to the second UE, determining the resource locations for transmitting the first information based on trigger signaling or trigger conditions. Herein, the other UE may be any other UE with a function of scheduling sidelink transmission except the first UE, that is, the other UE may also be the second UE.

In another example of the first embodiment, determining the resource locations for transmitting the first information based on resources configured or scheduled by the BS/a higher layer of the first UE/other UE further includes determining the resources configured or scheduled by the BS/higher layer/other UE according to at least one of the following: resource pool-specific parameters related to the first information, parameters related to the first information determined based on identities of the transmitter UE and/or receiver UE, parameters related to the first information determined based on a priority, and parameters related to the first information determined based on geographic location information.

In another example of the first embodiment, if the first UE fails to transmit the first information at the resource locations for transmitting the first information, the method for UE coordination performed by the first UE further includes at least one of the following: reselecting the resource locations for transmitting the first information; dropping the transmission of the first information at the resource locations; postponing the transmission of the first information at the resource locations. Optionally, if the first UE reselects the resource locations for transmitting the first information, the first UE regenerates or updates the first information and transmits the regenerated or updated first information at the reselected resource locations for transmitting the first information.

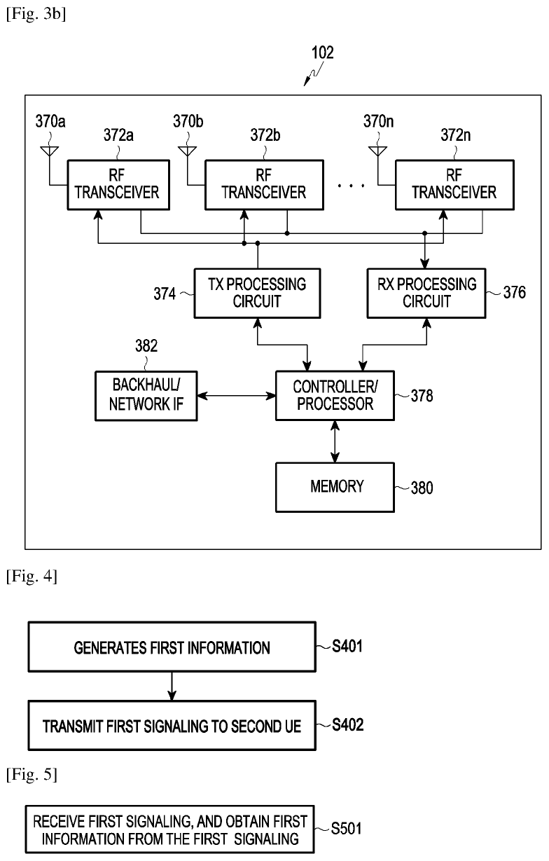

FIG. 5 is a flowchart of a method performed by a second UE in the first embodiment.

As shown in FIG. 5, in the first embodiment, the second UE performs the following steps to coordinate with a first UE:

Step 501: receiving first signaling and obtain first information from the first signaling.

In the first embodiment, optionally, the second UE also performs at least one of the following steps to coordinate with the first UE:

Step 502: determining whether the first information is valid, and/or determining whether a sidelink resource set including one or more sidelink resources indicated in the first information is available;

Step 503: feeding back second signaling to the first UE, where the second signaling contains second information, herein the second information is used to determine whether the second UE successfully receives the first information and/or whether the second UE is able to use the first information.

In an example of the first embodiment, the second UE obtaining the first information includes at least one of the following: the second UE monitoring the resource pool and detecting the first information that possibly exists; and in the case that it is determined that the first information is obtained from the first UE, obtaining resource locations for the first UE to transmit the first information, and detecting the first information that possibly exists from the first UE at the resource locations.

In an example of the first embodiment, the second UE obtaining the first information includes at least one of the following: the second UE obtaining the first information on periodic specific resources in the resource pool; and/or when the second UE needs to transmit a sidelink channel, the second UE triggering to monitor specific resources in the resource pool and obtaining the first information. Herein, the periodic specific resources in the resource pool may include a complete resource pool or a subset of the resource pool.

In an example of the first embodiment, when the second UE needs to transmit a sidelink channel, the second UE obtaining the first information includes at least one of the following: obtaining the first information within a time range corresponding to channel sensing in the prior art; and obtaining the first information within a time range in which resource reselection may be performed in the prior art. Optionally, the methods may be used in the case that the second UE obtains the first information on periodic specific resources in the resource pool and in the case that the second UE triggers to monitor the specific resources in the resource pool to obtain the first information when the second UE needs to transmit a sidelink channel. For example, the second UE determines the specific resources within the time range corresponding to channel sensing in the prior art and/or within the time range in which resource reselection may be performed in the prior art, and obtains the first information on the determined specific resources.

In an example of the first embodiment, when the second UE needs to transmit a sidelink channel, the second UE obtaining the first information includes at least one of the following: after obtaining the first information, keep monitoring the resource pool until the sidelink channel is transmitted; and after obtaining the first information, keep monitoring the resource pool until the latest time point that resource reselection is able to be triggered.

In an example of the first embodiment, in the case that it is determined that the first information is invalid and/or the sidelink resource set including one or more sidelink resources indicated in the first information is unavailable (for example, occupied by other sidelink transmissions with higher priorities), the method for UE coordination performed by the second UE further includes at least one of the following: triggering resource reselection; and re-obtaining the first information.

In an example of the first embodiment, the determining whether the first information is valid further includes at least one of the following:
determining whether the distance of the first UE transmitting the first information is in a specific threshold range;
determining whether the signal strength of the first information or the signal strength corresponding to the first UE transmitting the first information is in a specific threshold range, where the signal strength may be determined by RSRP and/or CSI;
determining whether the first UE transmitting the first information belongs to a specific UE set; and
determining the timeliness of the first information. Further, when the second UE needs to transmit a sidelink channel, determining whether a time deviation between at least two of the following is in a specific threshold range: the time point when the first UE generates the first information, the time point when the second UE receives the first information, the time point when the second UE determines it needs to transmit the sidelink channel on the sidelink resources, the time point when the packet of the second UE arrives at the physical layer from a higher layer, and the time point when the second UE transmits the sidelink channel.

In an example of the first embodiment, the determining whether a sidelink resource set including one or more candidate sidelink resources indicated in the first information is available includes: determining whether each of one or more candidate sidelink resources indicated in the first information is available; excluding unavailable sidelink resources among the one or more candidate sidelink resources; determining whether a number of remaining available sidelink resources is in a specific interval, herein if the number is in the specific interval, determining that a candidate sidelink resource set including the one or more candidate sidelink resources is available; and if the number is not in the specific interval, determining that the candidate sidelink resource set including the one or more candidate sidelink resources is unavailable. For example, if there are N available sidelink resources remaining and the value of N is in a specific interval, it is determined that the sidelink resources indicated in the first information are available, otherwise, it is determined that the sidelink resources indicated in the first information are unavailable.

In an example of the first embodiment, if it is determined that the first information is valid and/or if at least one sidelink resource indicated in the first information is available, the second UE will not determine resources for sidelink transmission based on channel sensing, but select resources for sidelink transmission among available sidelink resources indicated in the first information.

In an example of the first embodiment, the second signaling is used to indicate at least one of the following: whether the second UE successfully receives the first information and whether the second UE is able to use the first information. Optionally, when the second UE judges that the first information is invalid and/or determines that the sidelink resources indicated in the first information are unavailable, it is determined that the second UE is not able to use the first information, otherwise it is determined that the second UE is able to use the first information.

In an example of the first embodiment, the second signaling includes at least one of the following: HARQ-ACK feedback, dedicated physical layer acknowledgement signaling, and dedicated higher layer acknowledgement signaling.

In an example of the first embodiment, if the sidelink resource set including one or more candidate sidelink resources indicated in the first information is unavailable, and/or if one or more candidate sidelink resources indicated in the first information are unavailable, and/or if one or more sidelink resources indicated in the first information are occupied by other higher-priority services, the second UE further performs the following steps to coordinate with the first UE: the second UE requests the first UE to update the first information. Optionally, the second UE requesting the first UE to update the first information includes the second UE transmitting third signaling to the first UE. Optionally, the third signaling includes at least one of the following: acknowledgement signaling indicating that the second UE fails to receive the first information, acknowledgement signaling indicating that the second UE is not able to use the first information, and dedicated update request signaling.

### Second Embodiment

The second embodiment describes another method for UE coordination.

When performing the UE coordination method, a UE initiating coordination is hereinafter referred to as the first UE, and the UE cooperating with the coordination is hereinafter referred to as the second UE. It should be noted that this distinction is only for convenience of description, and is not a limitation of UE functions, that is, any UE may initiate coordination as the first UE, and may also cooperate with the coordination as the second UE.

From the perspective of operations performed by the first UE, the UE coordination method in the second embodiment is as the following:

In the second embodiment, the first UE generates first information and transmits the first information to a second UE.

In an example of the second embodiment, the first information includes at least one of the following: a candidate sidelink resource set, information related to resources for transmitting the first information, and sidelink configuration.

Optionally, the candidate sidelink resource set is used to assist the second UE to determine resources used by the second UE for sidelink transmission.

Optionally, the sidelink configuration includes at least one of the following: resource pool-specific configuration, UE-specific sidelink configuration, sidelink configuration for the first UE, and sidelink configuration for the second UE. Contents of the sidelink configuration includes at least one of the following: resource pool configuration, channel sensing configuration, Discontinuous Reception (DRX) configuration, and relay configuration. Herein, the channel sensing configuration includes at least one of the following: type of the channel sensing, such as legacy sensing, partial sensing and random selection; and parameters used in the channel sensing process.

In another example of the second embodiment, the first information is carried in at least one of the following: radio resource control (RRC) signaling, medium access control (MAC) signaling, and physical layer signaling.

Optionally, the physical layer signaling includes sidelink control information (SCI), which further includes a 1st stage SCI and/or a 2nd stage SCI. The first information may be carried in the SCI. Optionally, the SCI includes a specific field for indicating the first information, and the specific field does not exist in the prior art, that is, a newly introduced field. Optionally, the SCI includes a specific field for indicating the first information, and the specific field reuses the fields in the prior art. Optionally, the SCI additionally indicates whether the content indicated in the specific field is the first information.

For example, the first information includes one or more sidelink resources (which may also be called a candidate sidelink resource set), and the specific field for indicating the first information may reuse the field for indicating reserved sidelink resources in the prior art, such as the “Frequency resource assignment” and “Time resource assignment” fields in SCI format 0-1. In the prior art, the above two fields are used to indicate the frequency-domain locations and the time-domain locations of the reserved sidelink resources respectively, and two or three resource locations may be indicated according to the configuration of the higher layer parameter “sl-MaxNumPerReserve”.

Optionally, the SCI also indicates whether the SCI carries the first information, and/or whether the content indicated in the specific field is the first information. The method of indication includes explicit/direct indication and/or implicit/indirect indication.

For example, the above implicit/indirect indication includes indirectly indicating whether the content indicated in the specific field of the SCI is the first information through (combination of) values of one or more fields in the SCI in the prior art; and the above implicit/indirect indication also includes indirectly indicating whether the content indicated in the specific field of the SCI is the first information by using SCI format, for example, introducing a new SCI format for indicating the first information.

For example, the above explicit/direct indication includes that the SCI additionally indicates whether the content indicated in the specific field is the first information. For example, through a 1-bit indication, when the value of the 1-bit is ‘1’, the sidelink resource locations indicated in the specific field of the SCI are reserved by the first UE, for example, for subsequent transmission of the first UE; and when the value of the 1-bit is ‘0’, the specific field of the SCI indicates the first information, specifically, the sidelink resource locations indicated in the specific field of the SCI are the resource locations corresponding to the candidate sidelink resource set determined by the first UE, for example, are sidelink resource locations assumed by the first UE to be available for the second UE for sidelink transmission.

Optionally, the first information is carried in higher layer signaling, which includes MAC signaling and/or RRC signaling. Specifically, the higher layer signaling indicates the first information in the form of a bitmap, which corresponds to a sidelink resource set within a specific range, and each bit corresponds to one sidelink resource in the sidelink resource set. If the value of the bit is ‘1’, the corresponding sidelink resource is available; otherwise, if the value of the bit is ‘0’, the corresponding sidelink resource is unavailable.

The specific range is determined according to at least one of the following: the time point of transmitting the first information, the time range corresponding to the first information, the frequency-domain range corresponding to the first information, and the sidelink resource pool configuration. For example, if the first information is transmitted on slot t, the specific range includes slots [t-t1, t-t2], including PRBs allocated to the sidelink resource pool in frequency-domain. Further, the specific range or parameters for determining the specific range are based on at least one of the following: priority, geographical location and UE identity. The priority includes the priority of the service or the priority corresponding to PSSCH, which may be indicated by QoS. The geographic location may be indicated by higher layer signaling or a zone ID. The UE identity includes the layer 1 ID of the UE, and further includes the source ID, destination ID and group ID corresponding to the UE. An example is that the specific range or parameters for determining the specific range are configured by a higher layer, and the configuration is priority-specific.

In another example of the second embodiment, the UE divides the resources configured for sidelink communication within the specific range into several sidelink resources according to a specific time-domain granularity and/or a specific frequency-domain granularity, where the time-domain granularity may be one slot and the frequency-domain granularity may be one or N sidelink subchannels. The UE determines indexes of the several sidelink resources according to a predetermined order (for example, frequency-domain first and time-domain second), and generates a bitmap according to the indexes, so that the sidelink resource with index K corresponds to the Kth bit in the bitmap.

In another example of the second embodiment, the first information is carried in one or more signaling.

Optionally, part of the first information is carried in SCI, and the other part is carried in MAC signaling or RRC signaling. Further, the MAC signaling or RRC signaling may be mapped to PSSCH resources indicated in the SCI carrying part of the first information. The advantage of this method is that the second UE may obtain the first information carried in multiple signaling after receiving once, that is, after receiving a sidelink resource transmitting the SCI and PSSCH, so as to obtain the complete first information more quickly.

Optionally, part of the first information is carried in one SCI (called SCI-1), and the other part is carried in another SCI (called SCI-2). Accordingly, the second UE monitors the sidelink resources, obtains SCI-1 and SCI-2, determines both SCIs carry the first information according to the information indicated in SCI-1 and SCI-2, and obtains the first information in the two SCIs respectively. The advantage of this method is that the latency of indicating the first information in physical layer signaling is lower, but the number of bits available for indicating the first information in physical layer signaling may be less than that of the higher layer signaling, so carrying the first information in multiple physical layer signaling can increase the number of first information that can be indicated by physical layer signaling.

In another example of the second embodiment, the first information is carried in M signaling, and the value of M is determined based on priority and/or latency requirement, where the priority may be determined by QoS parameter of the service or priority parameter of layer 1, and the latency requirement may be determined by PDB (packet delay budget) parameter of the service. For example, when the priority belongs to a specific threshold range, M may be greater than 1, otherwise M=1. The method can enable the UE to obtain more complete first information when transmitting high-priority services. For example, when the latency requirement belongs to a specific threshold range, M may be greater than 1, otherwise M=1. The method can enable the UE to obtain a plurality of signaling carrying the first information within the allowable latency range of the service when the UE transmits a service with a relatively low latency requirement, i.e., a service with a relatively larger latency allowed, so as to obtain more complete first information.

Optionally, the first information includes N candidate resources, where the value of N is (pre-)configured/(pre-)defined, and further, it is priority-specific. Optionally, the value of M is determined by the signaling capacity and the value of N. For example, when the N candidate resources cannot be indicated in one signaling due to the limitation of the number of information bits, M>1, otherwise M=1.

In another example of the second embodiment, the first UE generating and transmitting the first information to the second UE includes the first UE periodically generating and transmitting the first information to the second UE, and/or the first UE being triggered to generate and transmit the first information to the second UE when certain conditions are met.

Optionally, the specific conditions include at least one of the following: transmission of the first information is configured to be enabled by the BS; a specific second UE is detected; a first information request from a second UE is received; and a signaling from a second UE is received, which indicates that the second UE fails to receive the first information.

In another example of the second embodiment, if the first UE receives second signaling from the second UE indicating that the second UE fails to receive the first information, and/or indicating that the first information is unavailable to the second UE, the first UE retransmits the first information, and/or regenerates the first information and transmits the regenerated first information.

Optionally, the second signaling includes at least one of the following: HARQ-ACK signaling, which may be used to indicate whether the reception of higher layer signaling carrying the first information is successful or whether the reception of physical layer signaling carrying the first information is successful; dedicated physical layer signaling, such as a specific sequence used to indicate whether the reception of the first information is successful; and dedicated higher layer signaling.

In another example of the second embodiment, after the first UE generates the first information and after the resource locations for transmitting the first information are determined, the first UE transmits the first information to the second UE at the determined resource locations.

Optionally, the resource locations for transmitting the first information are determined based on at least one of the following: channel sensing; resources configured or scheduled by a third node, which is any one of a base station, a higher layer of the first UE, and any UE except the first UE; and trigger signaling or trigger condition, which is used to trigger the first UE to generate and transmit the first information.

Optionally, the resource locations for transmitting the first information are determined based on channel sensing. Herein, channel sensing includes channel sensing in the prior art, and/or partial sensing and random selection. Further, the first UE may adjust the channel sensing method according to the information of the second UE. For example, the first UE may adjust the location and length of a sensing window and/or a resource selection window in the channel sensing process accordingly according to a time range expected for the second UE to receive the first information. And for example, the first UE may adjust the location and length of the sensing window and/or the resource selection window in the channel sensing process and a threshold used in the resource sensing process accordingly according to the identity of the second UE or the priority corresponding to the second UE.

Optionally, the resource locations for transmitting the first information are determined based on the following: resources configured or scheduled by a third node, and/or preconfigured/predefined information. Further, the resources configured or scheduled by the third node include the resources configured or scheduled by the third node determined according to at least one of the following: resource pool-specific parameters related to the first information, parameters related to the first information determined based on identities of the transmitter UE and/or receiver UE, parameters related to the first information determined based on a priority, and parameters related to the first information determined based on geographic location information. Herein, the third node includes at least one of a base station (BS), a first UE, a second UE and a other UE.

For example, the third node is a BS, and the first UE obtains resources semi-statically scheduled or dynamically scheduled by the BS and transmits the first information on the resources. Optionally, the first UE obtains specific resources scheduled by the BS for the first information, that is, the resources scheduled for the first information and the resources scheduled for other sidelink transmissions by the BS are independent of each other. And/or, the first UE obtains any sidelink resource scheduled by the BS and transmits the first information on the sidelink resource when the sidelink resource is available for transmission of the first information (for example, size of the sidelink resource is large enough).

For another example, the third node is a BS, and the first UE obtains configuration corresponding to the transmission of the first information from the BS, and determines the resource locations for transmitting the first information according to the configuration. Further, the configuration corresponding to the transmission of the first information includes at least one of the following: a transmission period of the first information; an offset between the resource locations used for the transmission of the first information and a predetermined reference point; indexes of resources for transmitting the first information; and a mapping relationship between the indexes of resources for transmitting the first information and the specific resource locations. The configuration corresponding to the transmission of the first information may be configured directly or indirectly, and it may be cell-specific, resource pool-specific, UE-specific, priority-specific, region-specific, service-specific or transmission-specific. In a specific example, the first UE obtains the transmission period T corresponding to the transmission of the first information and a time offset delta t between the resource locations used for the transmission of the first information and the predetermined reference point from the BS, and determines that the time-domain location of the resource used for the transmission of the first information is slot delta t+k*T accordingly according to the preconfigured predetermined reference point SFN=0, where k is a non-negative integer; the first UE obtains the mapping relationship between the indexes of resources for transmitting the first information and the specific resource locations, specifically, the first UE obtains the resource range for transmitting the first information with a frequency-domain size of M subchannels (or PRBs) and specific locations of the M subchannels, and determines that the frequency-domain location of resources for transmitting the first information is the mth subchannel among the M subchannels according to the identity UEID1 of the first UE itself and a preconfigured formula, m=(UEID1+delta f) mod M, where delta f is a frequency-domain offset preconfigured or configured by the BS.

The third node in each of the above examples may also be replaced by other nodes from the BS. For example, the third node is the second UE, and the first UE obtains the configuration corresponding to the transmission of the first information from the second UE, and determines the resource locations for transmitting the first information according to the configuration. For example, the first UE determines the frequency-domain locations of the resources used for the transmission of the first information according to the identity UEID2 of the second UE and a preconfigured formula, where the specific method is similar to that in the previous example.

Optionally, the resource locations for transmitting the first information are determined based on the following: if the first UE is triggered to generate and transmit the first information to the second UE, determining the resource locations for transmitting the first information based on trigger signaling or trigger conditions. Herein, determining the resource locations for transmitting the first information based on trigger signaling includes determining the resource locations for transmitting the first information according to the information indicated in the trigger signaling and/or the resources receiving the trigger signaling. For example, the first UE receives the trigger signaling carried in SCI or MAC CE, in which the sidelink resource locations are explicitly or implicitly indicated, and the first UE assumes that the sidelink resource locations are used for the first information to be transmitted to the second UE. Herein, determining the resource locations for transmitting the first information based on trigger conditions includes determining based on a predetermined/configured mapping relationship between the trigger conditions and the resource locations for transmitting the first information, and accordingly, the resource locations for transmitting the first information are determined based on the trigger conditions and the mapping relationship.

In another example of the second embodiment, if the first UE fails to transmit the first information at the resource locations for transmitting the first information, at least one of the following methods is used:
reselecting the resource locations for transmitting the first information. For example, the reselection is performed by reusing the above methods for determining the resource locations for transmitting the first information. Further, methods of reselecting and first selecting the resource locations for transmitting the first information, and/or specific parameters/configurations used may be the same or different;
dropping the transmission of the first information at the resource locations;
postponing the transmitting of the first information at the resource locations. Specifically, the first information is postponed to be transmitted at the next available resource location for transmitting the first information, or the first information is postponed to be transmitted at the next available sidelink resource.

Optionally, the above methods may be selected based on at least one of the following: priority of the sidelink transmission, priority of the second UE, identity of the second UE, type or identity of the first UE, configuration or scheduling information of the BS/higher layer/second UE, and geographic location of the first UE and/or the second UE. For example, after the first UE determines the resource locations for transmitting the first information, if the first information is not able to be transmitted at the resource locations, when the second UE needs to transmit high-priority sidelink services, or when the identity of the second UE corresponds to a high-priority node, the first UE reselects the resource locations for transmitting the first information; otherwise, the first UE drops the transmission of the first information at the resource locations.

Accordingly, from the perspective of operations performed by the second UE, the UE coordination method in the second embodiment is as the following:

In the second embodiment, corresponding to the first UE generating and transmitting the first information, the second UE receives the first information and uses the received first information.

In the second embodiment, optionally, the second UE receives the first information and/or triggers the first UE to transmit the first information periodically and/or as required. The requirements include that the second UE needs to transmit a sidelink signal/channel, and that the second UE has no resources available for transmitting the sidelink signal/channel.

In an example of the second embodiment, the second UE receiving the first information includes the second UE determining resources for transmitting the first information and receiving the first information on the resources. Further, the second UE obtains the first information on periodic specific resources in the resource pool; and/or, if the second UE needs to transmit the sidelink channel on sidelink resources, the second UE triggers to monitor specific resources in the resource pool and obtains the first information.

Optionally, the resources for transmitting the first information may be the whole resource pool, that is, the UE blindly detects the first information that possibly exists on the whole resource pool; and/or, the resources may be a specific subset of the resource pool, and the UE only needs to blindly detect the first information that possibly exists on the specific subset.

Optionally, in the latter case, if the UE is (pre-)configured/(pre-)defined as not needing to receive the sidelink data, the UE may only monitor on the specific subset and not on the rest resources in the resource pool, thereby reducing the power consumption caused by the monitoring. In this case, a method for the second UE to determine the resources for transmitting the first information includes: the second UE determines to obtain the first information from the first UE, obtains the resource locations where the first UE transmits the first information, and detects the first information that possibly exists from the first UE at the resource locations. Herein, The first UE may also be replaced by a set of the first UEs. For example, if the second UE assumes that the first information may be obtained from one or several UEs in the set of the first UEs, but is not sure which specific UEs are, the second UE detects the resources for transmitting the first information that may correspond to the set of the first UEs.

In an example of the second embodiment, the second UE obtaining the resource locations where the first UE transmits the first information includes: obtaining all or part of the information used by the first UE to determine the resource locations where it transmits the first information; and according to the all/part of the information, adopting a method similar to that of the first UE accordingly, to determine the resource locations where the first UE transmits the first information.

Optionally, the first UE obtains the scheduling information or configuration corresponding to the resources for transmitting the first information from the BS, and the second UE also obtains the scheduling information or configuration from the BS. Optionally, the second UE determines to obtain the first information from the first UE, reports the determined first UE to the BS, and obtains the scheduling information or configuration corresponding to the first UE from the BS.

Optionally, the second UE determines by itself the scheduling information or configuration corresponding to the resource locations for receiving the first information from the first UE, and transmits the scheduling information or configuration to the first UE. For example, the scheduling information or configuration may be all or part of the information in the Discontinuous Reception (DRX) configuration of the second UE, and by indicating its own DRX configuration to the first UE, the second UE may enable the first UE to determine on which resources the second UE has the ability to receive the first information, and enable the first UE to determine the resources for the first information to be transmitted to the second UE correspondingly.

In an example of the second embodiment, if the second UE needs to transmit the sidelink channel on the sidelink resources, obtaining the first information includes at least one of the following: obtaining the first information within a time range corresponding to the channel sensing in the prior art; and/or, obtaining the first information within a time range in which resource reselection may be performed in the prior art. For the former, specifically, in the prior art, the sidelink UE determines the time range (referred to as transmission window/selection window for short) that may be used for transmitting the sidelink data according to an expected time point for transmitting the sidelink data and/or a time point when the sidelink data arrives at the physical layer from the higher layer, and determines the time range (referred to as sensing window for short) for channel sensing according to the transmission window. Accordingly, in the first embodiment, the second UE may obtain the first information in the sensing window and/or the transmission window. For the latter, specifically, in the prior art, after the sidelink UE selects resources for transmitting the sidelink data, it may reselect the resources for transmitting the sidelink data based on a criteria such as whether the resources for transmitting the sidelink data conflicts with other high-priority sidelink transmissions within a time range earlier than the resources in time-domain and with a time-domain interval not exceeding a specific length from the resources according to the limitations of UE capability. Accordingly, in the first embodiment, the second UE may obtain the first information within the time range.

In an example of the second embodiment, if the second UE needs to transmit the sidelink channel on the sidelink resources, obtaining the first information includes at least one of the following: after obtaining the first information, keep monitoring the resource pool until the sidelink channel is transmitted, or keep monitoring the resource pool until the latest time point that resource reselection is able to be triggered.

In an example of the second embodiment, if the second UE needs to transmit the sidelink channel on the sidelink resources, obtaining the first information includes at least one of the following items: if it is determined that the selected resources for transmitting the sidelink channel become unavailable (for example, occupied by other sidelink transmissions with a higher priority) in the process of monitoring the resource pool, triggering resource reselection, and/or re-obtaining the first information.

In an example of the second embodiment, after receiving the first information, the second UE determines whether the first information is valid, and/or, determines whether the sidelink resources indicated in the first information are available.

Optionally, determining whether the first information is valid further includes:
determining whether the distance of the first UE transmitting the first information is in a specific threshold range;
determining whether the signal strength of the first information or the signal strength corresponding to the first UE transmitting the first information is in a specific threshold range, where the signal strength may be determined by RSRP and/or CSI;
determining whether the first UE transmitting the first information belongs to a specific UE set; and
determining the timeliness of the first information. Further, if the second UE needs to transmit the sidelink channel on the sidelink resources, determining whether a time deviation between at least two of the following is in a specific threshold range: the time point when the first UE generates the first information, the time point when the second UE receives the first information, the time point when the second UE determines it needs to transmit the sidelink channel on the sidelink resources, the time point when the packet of the second UE arrives at the physical layer from a higher layer, and the time point when the second UE transmits the sidelink channel.

In an example of the second embodiment, the second UE determines whether the first information is valid by determining whether the first UE transmitting the first information belongs to a specific UE set. In this example, the second UE receives the first information from any UE, and then determines whether the received first information is valid according to the identity of the transmitter UE of the first information.

In another example of the second embodiment, the second UE determines whether the first information is valid by determining whether the first UE transmitting the first information belongs to a specific UE set. In this example, the second UE determines to receive the first information from the first UE, and considers the first information from other UEs is invalid, so it does not receive the first information from other UEs. Optionally, if the first signaling indicates whether the first signaling carries the first information, the second UE determines whether it needs to receive the first information, and if it does not need to receive the first information, it will not decode the first signaling carrying the first information. Optionally, if the first signaling indicates whether the first signaling carries the first information and the second UE needs to receive the first information, the second UE will only decode the first signaling transmitted by the first UE carrying the first information, and will not decode the first signaling transmitted by other UEs carrying the first information.

For example, the first signaling includes SCI and PSSCH associated with the SCI, and the SCI explicitly or implicitly indicates whether the PSSCH carries the first signaling. In this example, the second UE determines that it needs to receive the first information from the first UE, and does not receive the first information from other UEs. The second UE receives the SCI and judges whether the associated PSSCH carries the first information according to an indication in the SCI; if the associated PSSCH carries the first information, the second UE further needs to judge whether the source ID indicated by the SCI is the source ID of the first UE. If the associated PSSCH carries the first information and the source ID indicated by the SCI is the source ID of the first UE, the second UE decodes the associated PSSCH; otherwise, the second UE does not decode the associated PSSCH. Optionally, before/after any of the above judgments, the second UE further judges whether the destination ID indicated by the SCI belongs to itself, and/or whether the SCI indicates that the cast type is broadcast; if so, determining whether to decode the associated PSSCH according to results of the above judgments; and if not, the second UE does not decode the associated PSSCH.

In the prior art, the sidelink UE only determines whether to decode the PSSCH associated with SCI by judging whether the destination ID indicated in the SCI belongs to itself and/or judging the transmission type. However, in this example, for the reception of the first signaling carrying the first information, a determination based on the source ID is additionally introduced. In this example, even if the destination ID indicated in the SCI belongs to the second UE or broadcast is indicated in SCI, the second UE will further determine whether the source ID is the source ID of the first UE, thus achieving an effect of only receiving the first information from the first UE. The advantage of this example is that the first information may be transmitted by the sidelink UE to all other surrounding UEs that need the first information through broadcast/multicast, and there is no specific receiving object, that is, the second UE may or may not need to receive the first information broadcast by some sidelink UE; in addition, the second UE may detect a plurality of UEs transmitting the first information, and may only need to receive the first information transmitted by a specific one or several UEs therein according to the actual service requirements (for example, whether sidelink communication with a plurality of UEs exists). Therefore, this example allows the second UE to accept only the first information from the specific first UE, thus reducing the number of times of unnecessary decoding.

In an example of the second embodiment, the sidelink resources indicated in the first information are obtained, that is, a candidate sidelink resource set including the candidate sidelink resources indicated in the first information is obtained; whether each sidelink resource indicated in the first information is available is determined; unavailable sidelink resources are excluded; whether the number of remaining available sidelink resources is in a specific interval is determined, herein if the number of remaining available sidelink resources is in the specific interval, judging that the candidate sidelink resource set is available; and if the number of remaining available sidelink resources is not in the specific interval, judging that the candidate sidelink resource set is unavailable. For example, if there are N available sidelink resources remaining and the value of N is in a specific interval, it is determined that the sidelink resources indicated in the first information are available, otherwise, it is determined that the sidelink resources indicated in the first information are unavailable.

In an example of the second embodiment, optionally, if the second UE needs to transmit the sidelink channel on the sidelink resources, then:
if the UE needs to receive downlink/sidelink transmission on time-domain resources where a certain sidelink resource indicated in the first information is located, and the downlink/sidelink transmission has a higher priority than that of the sidelink channel that needs to be transmitted, and the UE cannot receive downlink/sidelink transmission and transmit the sidelink channel at the same time, then the certain sidelink resource is unavailable;
if the UE needs to transmit uplink/sidelink transmission on time-domain resources where a certain sidelink resource indicated in the first information is located, and the uplink/sidelink transmission has a higher priority than that of the sidelink channel that needs to be transmitted, and the UE cannot to transmit uplink/sidelink transmission and transmit the sidelink channel at the same time, then the certain sidelink resource is unavailable; and
if the UE supports DRX and/or is configured with DRX, and the UE is in a DRX off state on a certain sidelink resource indicated in the first information (for example, the UE is in a sleep state on the certain sidelink resource indicated in the first information), then the certain sidelink resource is unavailable.

Optionally, if the first information is valid, or if the first information is valid and at least one or at least N sidelink resources indicated in the first information are available, the second UE will not perform channel sensing and will not determine resources for sidelink transmission based on channel sensing, but will select resources for sidelink transmission among available sidelink resources indicated in the first information. Where N is a (pre-)configured non-negative integer.

Optionally, after receiving the first information, the second UE feeds back second signaling to the first UE, where the second signaling is used to indicate at least one of the following: whether the second UE successfully receives the first information, and whether the second UE is able to use the first information. Accordingly, after transmitting the first information to the second UE, the first UE receives the second signaling fed back by the second UE, and determines whether the first information needs to be regenerated and/or whether the first information needs to be transmitted to the second UE again according to the content of the second signaling.

The second signaling includes at least one of the following: HARQ-ACK feedback; dedicated physical layer acknowledgement signaling; and dedicated higher layer acknowledgement signaling.

Optionally, after the second UE obtains the first information, if the sidelink resources indicated in the first information are unavailable, and/or if the sidelink resources indicated in the first information are occupied by other higher-priority services, the second UE requests the first UE to update the first information. The second UE requesting the first UE to update the first information includes the second UE transmitting third signaling to the first UE, which includes at least one of the following: signaling indicating that the second UE fails to receive the first information, signaling indicating that the second UE is not able to use the first information, and signaling dedicated to the update request.

In an example of the second embodiment, after the second UE requests the first UE to update the first information, it receives and uses the updated first information. Further, the second UE determines resources for transmitting the updated first information and receives the updated first information on the resources, of which the specific method is similar to the method for determining the resources for the initial first information in the above examples, and the description thereof will not be repeated.

### The Third Embodiment

The third embodiment describes another method for UE coordination.

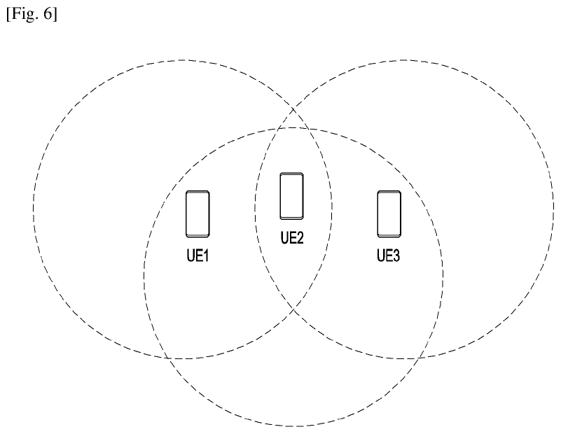

There is a problem of hidden nodes in a wireless communication system, which manifests that in wireless communication, the wireless environments of the transmitting node and the receiving node are usually different, so other nodes that interfere with the receiving node may not be visible at the transmitting node, i.e., hidden. Therefore, the transmitting node cannot perceive the interference of the hidden node, so it cannot try to avoid the interference accordingly. FIG. 6 is an example of the hidden node problem, in which both UE1 and UE3 are in the communication range of UE2, but they are out of the communication range of each other, therefore, when UE1 is a TX UE, it cannot perceive the interference from UE3, however the interference from UE3 would actually cause damage to UE2 receiving the transmission of UE1.

In communication Mode 2 of the existing sidelink communication system, the sidelink UE determines potential wireless interference through channel sensing, and selects resources with less interference for transmitting the sidelink signal. The hidden node problem will negatively affect the performance of Mode 2.

Therefore, in the sidelink communication system, if the UE as the receiving end of the sidelink signal can provide the UE as the transmitting end of the sidelink signal with information for assisting the transmission of the transmitting end UE, the transmitting end UE may sense better and select resources with less interference to the receiving end UE, thus improving the reliability of the wireless communication. In the third embodiment, a method for UE coordination is described for a scenario where the receiver UE of the sidelink service provides assistance information to the transmitter UE of the sidelink service. However, unless otherwise specified, technical methods used in the third embodiment may also be used in other scenarios and other embodiments. For example, the methods may be used in a scenario corresponding to the fourth embodiment where the first UE is triggered to transmit the first information after receiving third signaling from the second UE. In this scenario, there may be or may be no sidelink service transmission between the first UE and the second UE.

In an example of the third embodiment, the first UE serves as the receiver UE of the sidelink service, and the second UE serves as the transmitter UE of the sidelink service. In this example, the first UE transmits first information to the second UE, and the second UE may obtain content in the first information and use the obtained content in the process of determining resources used for transmitting the sidelink transmission.

In an example of the third embodiment, the first information is carried in M first signaling, where the first signaling may be SCI and/or PSSCH. Further, the M first signaling includes at least one of the following: M SCIs; M PSSCHs; M SCIs and PSSCHs associated with the M SCIs; and N PSSCHs, where the N PSSCHs include M higher layer signaling as the first signaling, and the values of N and M may be the same or different.

In an example of the third embodiment, the value of M is determined according to the number of bits of the first information and the capacity of the first signaling. For example, if the first information includes C1 sidelink resource locations and the first signaling can indicate C2 sidelink resource locations at most, then M=C1/C2 or M=ceil (C1/C2). In a specific example, the method of indicating the locations of the sidelink resources in the first information reuses the method of indicating the sidelink locations in SCI in Release 16, that is, the location of each sidelink resource is indicated by a frequency-domain location field and a time-domain location field. The first signaling may be SCI, and the field indicating the sidelink locations in SCI format in Release 16 is reused, and according to Release 16, C2=3. In another specific example, the method of indicating the locations of the sidelink resources in the first information is by means of a bitmap with length C1, and each bit corresponds to one specific sidelink resource unit, such as one subchannel in the frequency-domain and one slot in the time-domain. The first signaling may be MAC CE, and the length of the payload used to indicate the sidelink resource locations in the MAC CE is C2 bits.

In another example of the third embodiment, the value of M is configured by RRC, and further, is configured per priority. For example, for services with priorities 0˜7, the configured values of M thereof are M0˜M7 respectively. The method may enable the service with a higher priority to correspond to a larger number of first signaling, so that the service with a higher priority corresponds to the first information with a larger number of bits and carrying more information, so that the first information may better improve the performance of the service with a higher priority. And, the method may enable the service with a lower priority to correspond to a less number of first signaling, thereby reducing the overhead of the first information corresponding to a lower-priority service.

In an example of the third embodiment, M is the number of first signaling for carrying first information; or M represents the maximum number of the first signaling for carrying the first information, and the number of first signaling actually transmitted may be less than or equal to M. Optionally, the first signaling also indicates at least one of the following: the value of M; and an index of the first signaling, for example, an index of the first signaling among the total of M first signaling. Optionally, the length of the field for indicating any of the above information is determined according to the value of M.

In an example of the third embodiment, when the first UE transmits the first information, it determines the destination UE of the first information as the second UE, and determines the resource locations for transmitting the first information according to a time range in which the second UE may receive the first information. Accordingly, the second UE determines the resource locations for receiving the first information according to its own (pre-)configured/(pre-)defined time range for receiving the first information. Determining the destination UE as the second UE includes determining according to the transmission and reception status of the sidelink service.

Optionally, at least one of the following methods is used to determine the time range in which the second UE may receive the first information:
determining the time range in which the second UE may receive the first information according to resource pool-specific parameters of the first information. For example, the resource pool configuration includes a field corresponding to the first information, which indicates a resource set in the resource pool used for the first information transmission; and then the time range in which the second UE may receive the first information determined by the first UE is the set or a subset of the set;
determining the time range in which the second UE may receive the first information according to the identity of the second UE and according to a (pre-)configured/(pre-)defined mapping relationship between the identity of the second UE and the resource range. The identity includes a destination ID of the second UE, which may be a unicast/multicast/broadcast destination ID and/or a higher layer ID of the second UE; and/or includes the identity of the service, specifically, the identity of the sidelink service transmitted between the first UE and the second UE. For example, it is determined that the time range in which the second UE may receive the first information is a subframe satisfying mod (L1ID, T)=0, where L1ID is the identity of the second UE or a parameter determined based on the identity of the second UE, and T is (pre-)configured/(pre-)defined;
determining the time range in which the second UE may receive the first information according to a priority. The priority is a priority of the sidelink service transmitted between the first UE and the second UE, and furthermore, if multiple sidelink services are transmitted between the first UE and the second UE, the priority is the highest/lowest/average priority of the multiple sidelink services. For example, a resource set for transmitting the corresponding first information or a parameter for determining the resource set is configured for each priority, and the first UE determines that the time range in which the second UE may receive the first information is the corresponding resource set according to the priority. Specifically, the resource pool configuration includes a field of first information corresponding to each priority, which indicates the resource set for transmitting the corresponding first information. And/or, the mapping relationship between the identity of the second UE and the resource range is configured per priority;
determining the time range in which the second UE may receive the first information according to geographical location information of the second UE. For example, each geographical location is mapped to a specific resource range, and the method of determining the mapping is similar to the method of determining the resource range according to the identity of the second UE. The geographic location includes at least one of the following: zone ID and latitude and longitude information in Release 16, and geographic location areas divided in a subsequent release. For example, a radius of an area in Release 16 may be 10 meters to 500 meters, and the UE will pass through different areas more frequently during its movement. However, in a subsequent release, a larger-scale geographical location division may be introduced, and the UE will be in the same geographical location for a period of time, so as to transmit/receive the first information relatively stably using the resource range corresponding to the geographical location; and
determining the time range in which the second UE may receive the first information according to the DRX configuration of the second UE. For example, determining a DRX-on interval (i.e., an interval when the second UE is not in a sleep state) of the second UE according to the DRX configuration of the second UE, and taking this interval or a subset of this interval as the time range in which the second UE may receive the first information.

Optionally, after determining the time range in which the second UE may receive the first information, the first UE determines resources for transmitting the first information within the time range. For example, it is determined that the resource locations for transmitting the first information are a subset of the time range in which the second UE may receive the first information. Specifically, it includes any of the following:
randomly selecting resources for transmitting the first information within the time range in which the second UE may receive the first information;
determining resources for transmitting the first information according to sensing or partial sensing within the time range in which the second UE may receive the first information; and
calculating resources for transmitting the first information within the time range in which the second UE may receive the first information according to the identity of the first UE and/or the (pre-)configured/(pre-)defined parameters of the first UE for determining the resources for transmitting the first information. For example, when the time range in which the second UE may receive the first information includes K sidelink resources, the first UE determines to use the K1th sidelink resource to transmit the first information, where K1=mod (UEID1, K), and UEID1 is the identity of the first UE.

In another example of the third embodiment, when the first UE transmits the first information, it determines the destination UE of the first information as the second UE, or it does not determine the identity of the destination UE of the first information. The first UE determines the resource locations for transmitting the first information according to its own (pre-)configured/(pre-)defined time range for transmitting the first information. Accordingly, the second UE determines the resource locations for receiving the first information according to the time range in which the first UE may transmit the first information. For example, it is determined that the resource locations for receiving the first information includes the time range in which the first UE may transmit the first information or a subset of the time range in which the first UE may transmit the first information. Determining the destination UE as the second UE includes determining according to the transmission and reception status of the sidelink service, and scenarios in which the identity of the destination UE is not determined include scenarios in which the first UE knows the destination ID but cannot know which UEs are using the destination ID in connect-less multicast and broadcast.

Optionally, the second UE determines the time range in which the first UE may transmit the first information by using at least one of the following methods: determining the time range in which the first UE may transmit the first information according to the resource pool-specific parameters of the first information; determining the time range in which the first UE may transmit the first information according to the identity of the first UE and a (pre-)configured/(pre-)defined mapping relationship between the identity of the first UE and the resource range; determining the time range in which the first UE may transmit the first information according to a priority; determining the time range in which the first UE may transmit the first information according to the geographic location information of the first UE; and determining the time range in which the first UE may transmit the first information according to the DRX configuration of the first UE. The specific methods are similar to that in the previous example, and the description thereof will not be repeated.

In another example of the third embodiment, the second UE schedules the first UE to transmit the first information at specific resource locations, and the first UE transmits the first information at the corresponding specific resource locations according to the scheduling of the second UE.

In another example of the third embodiment, the first UE schedules the second UE to receive the first information at specific resource locations, and the second UE receives the first information at the corresponding specific resource locations according to the scheduling of the first UE.

In an example of the third embodiment, after the first UE transmits the first information, it receives second signaling fed back by the second UE and obtains second information from the second signaling. Herein, the first UE determines resource locations for receiving the second signaling according to at least one of the following methods:
determining the resource locations for receiving the second signaling according to the resource locations for transmitting the first information and a mapping relationship between the resource locations of the first information and the second information;
determining the mapping relationship between the resource locations of the first information and the second information based on the identity of the first UE;
determining the mapping relationship between the resource locations of the first information and the second information based on the identity of the second UE;
determining the mapping relationship between the resource locations of the first information and the second information based on the priority and/or geographic location information;
the first UE scheduling the resource locations for transmitting the second signaling for the second UE, and determining that the scheduled resource locations are the resource locations for receiving the second signaling; and
the second UE scheduling the resource locations for receiving the second signaling for the first UE.

Accordingly, the second UE determines the resource locations for transmitting the second signaling according to at least one of the above methods, which are not listed in detail again.

If the first UE determines according to the second information that the second UE fails to receive the first information successfully, and/or the second UE is not able to use the first information, it regenerates the first information and transmits the first information to the second UE, and/or retransmits the first signaling containing the first information to the second UE, that is, triggers the retransmission of the first signaling. The first UE also needs to determine sidelink resources for the regeneration and transmission of the first signaling and/or for the retransmission of the first signaling. Optionally, the method for the first UE to determine the sidelink resources includes at least one of the following:
reuse any method in which the first UE selects the resource locations for transmitting the first information in the above examples;
determining that the sidelink resource is the earliest sidelink resource available for the first UE within the time range in which the second UE may receive the first information. The resources available for the first UE include the resources that do not conflict with other higher priority services after the first UE regenerates the first signaling;
if the time range in which the second UE may receive the first information is periodic, determining that the sidelink resources are resources in the current period; and
if the time range in which the second UE may receive the first information is periodic, determining that the sidelink resources are resources in the next period.

### The Fourth Embodiment

The fourth embodiment describes another method for UE coordination.

In the existing sidelink communication system, a UE may determine potential interference sources in the wireless environment by channel sensing, so that when it needs to transmit a sidelink signal/channel, it may exclude the sidelink resources that are not suitable for its transmission according to the results of the channel sensing. However, channel sensing requires the UE to keep monitoring the sidelink resources within a long time window before transmitting the sidelink signal/channel. If the UE may predict an approximate time point of transmitting the sidelink signal/channel, the location of the time window would be calculated accordingly according to the time point; otherwise, if the UE cannot predict when a sidelink packet will arrive at the physical layer from the higher layer and needs to be transmitted, the UE needs to keep monitoring and caching on the resource pool all the time. Both of these cases will cause large power consumption, especially for the latter case, the power consumption caused by channel sensing is significant. Existing sidelink communication systems mainly consider sidelink terminals that are insensitive to power consumption. However, in the future evolution versions, in order to further expand the application scope of sidelink communication systems, sidelink terminals that are sensitive to power consumption (such as pedestrian-held terminals, etc.) need to be included in the scope of sidelink UEs. Accordingly, for this type of UE, it is necessary to introduce a mechanism to reduce power consumption in the sidelink communication system. The method for UE coordination described in the fourth embodiment may be used to reduce power consumption. In this method, a UE which is insensitive to power consumption performs channel sensing and broadcasts its channel sensing results for using by other UEs which are sensitive to power consumption. Therefore, UEs which are sensitive to power consumption may only receive the sensing results of other UEs on limited sidelink resources, and use the sensing results of other UEs instead of their own channel sensing processes, thus greatly reducing the power consumption caused by channel sensing.

In addition, in the existing sidelink communication system, there is a typical scenario where multiple nodes keep short geographical distance for a long time, such as a platoon scenario. In this scenario, since the multiple sidelink UEs have distances short enough therebetween, the radio interference suffered by them is similar, a channel sensing result of one UE may be used for other UEs. The method for UE coordination described in the fourth embodiment may be used in this scenario, and this method enables only one UE among the multiple sidelink UEs to transmit its channel sensing results, for using by other UEs with a short distance, while other UEs may not transmit their own channel sensing results, thus significantly reducing the overhead caused by UE transmitting channel sensing results in the wireless communication system.

A typical scenario corresponding to this example includes that: the first UE is a specific node deployed in the sidelink communication system, for example, an infrastructure-type node, and is configured to provide first information (to other types of nodes); and, the first UE is a specific node in a product group, for example, the captain of a platoon. However, unless otherwise specified, technical methods used in the fourth embodiment may also be used in other scenarios and other embodiments. For example, the method used by the first UE to determine resources for transmitting the first information in the fourth embodiment may also be used in the process of determining resources for transmitting the first information in the third embodiment.

In an example of the fourth embodiment, the first UE periodically broadcasts/multicasts the first information, or the first UE is triggered to transmit the first information after receiving third signaling from the second UE.

In this example, optionally, the first UE may or may not know the identity of the second UE. For example, the first UE periodically broadcasts/multicasts the first information regardless of whether a nearby second UE is detected. For example, the first UE is triggered to transmit the first information after receiving the third signaling, and the third signaling may not carry the identity of the transmitter UE, for example, it is a public sequence; or, the third signaling may carry the identity of the transmitter UE, for example, it is an SCI indicating the source ID or a PSSCH associated with the SCI indicating the source ID. For example, the first UE is triggered to transmit the first information after receiving the third signaling from the BS, and the third signaling may or may not indicate the identity of the UE that needs to receive the first information.

In an example of the fourth embodiment, the first UE determines resources for transmitting the first information according to (pre-)configured/(pre-)defined information or scheduling information of the BS. Specifically, the first UE obtains periodic sidelink resources from the BS, which are indicated in an RRC IE dedicated to configuring transmission resources of the first information. Optionally, the RRC IE indicates at least one of the starting location, period and offset of the sidelink resources. Optionally, the first UE derives parameters for determining the sidelink resources according to its own identity and/or geographic location information. For example, the first UE determines that the starting location or offset of the sidelink resources is mod(UEID1, N), where UEID1 is the identity or zone ID of the first UE, and N is a (pre-)configured/(pre-)defined value.

In another example of the fourth embodiment, the first UE obtains a configured grant from the BS, and sidelink resources scheduled by the configured grant are used to transmit the first information. Optionally, the configured grant is associated with the first information, for example, the sidelink resources indicated in the configured grant may only be used for transmitting the first information but not for transmitting other sidelink signals, and/or, the first information may only be transmitted on the sidelink resources scheduled by the configured grant and cannot be transmitted on other sidelink resources scheduled by the BS. Optionally, the configured grant differs from an ordinary configured grant in at least one of the following: an index of the configured grant dedicated to the first information, and the RRC field dedicated to the first information (for example, the configured grant and the ordinary configured grant may have different RRC field suffixes/RRC field names). Herein, the ordinary configured grant refers to a configured grant that may be used for any type of sidelink transmission and without other restrictions, such as a configured grant in current Release 16.

In another example of the fourth embodiment, when the first UE is triggered to transmit the first information after receiving the third signaling from the second UE, the first UE determines resources for transmitting the first information according to the resources used by the third signaling and/or the information of the second UE and/or the resources scheduled by the second UE. The resources scheduled by the second UE may be indicated in the third signaling.

Accordingly, the second UE receives the first information, which includes that the second UE determines the resources or the resource range for the first UE to transmit the first information, and receives the first information on the resources/resource range.

In an example of the fourth embodiment, the second UE blindly detects the sidelink resource pool, or the second UE monitors the resource pool-specific resource set corresponding to the transmission of the first information, and detects the first UE that possibly exists. Optionally, if the first UE is detected, the second UE determines the resources or resource range for the first UE to transmit the first information, receives the first information on the resources/resource range, and drops the monitoring on other resources in the resource pool. For example, if the second UE determines according to the resource pool configuration information that subframes 0˜3 in each radio frame in the resource pool are configured for transmission of the first information, the second UE detects the first UE that possibly exists in subframes 0˜3. Subsequently, if the second UE detects the first UE in subframe 2, and determines that it uses subframe 2 to transmit the first information according to the identity of the first UE, the second UE receives the first information in subframe 2 and drops the monitoring on subframes 0˜1 and 3˜9.

In another example of the fourth embodiment, the second UE obtains geographic location information from the higher layer (e.g., V2X layer/application layer), determines resources used by the first UE that possibly exists in the area where the second UE is currently located according to the geographic location information, and receives the first information on the resources. Optionally, the second UE drops the monitoring on other resources in the resource pool. For example, according to that the identity or index of the current geographic area in the geographic location information is area2, the second UE determines that resources used by the first UE that possibly exists in the area where the second UE is currently located are subframe t=mod(area2, N), where N is a (pre-)configured/(pre-)defined value. The second UE receives the first information on subframe t and drops the monitoring on other subframes.

In another example of the fourth embodiment, the second UE obtains scheduling information of the first information from the BS and receives the first information on the sidelink resources indicated by the scheduling information. Optionally, the scheduling information includes DCI dedicated to the first information, and distinguishes from the sidelink scheduling information in the prior art by a specific DCI format. Or, the scheduling information uses an existing DCI format, and distinguishes from the sidelink scheduling information in the prior art by an indication in a newly added field in the existing DCI format and/or by the (combination of) values of the existing fields. Optionally, the scheduling information includes a MAC CE or RRC field dedicated to the first information, including at least one of the following:
periodic sidelink resources, which are indicated in an RRC IE dedicated to configuring transmission resources of the first information. Optionally, the RRC IE indicates at least one of the starting location, period and offset of the sidelink resources. Optionally, the second UE derives parameters for determining the sidelink resources according to the identity and/or geographic location information of the first UE. For example, the second UE determines that the starting location or offset of the sidelink resources is mod(UEID1, N), where UEID1 is the identity or zone ID of the first UE, and N is a (pre-)configured/(pre-)defined value; and
a configured grant, which differs from an ordinary configured grant in at least one of the following: an index of the configured grant dedicated to the first information, and the RRC field dedicated to the first information (for example, the configured grant and the ordinary configured grant may have different RRC field suffixes/RRC field names) Herein, the ordinary configured grant refers to a configured grant that may be used for any type of sidelink transmission and without other restrictions, such as a configured grant in current Release 16.

Taking the above embodiments as examples, this application provides a method for UE to assist other nodes in selecting resources, which facilitates other nodes to select resources more efficiently, and avoids interference that may be caused by hidden nodes in sidelink communication.

It can be understood by those skilled in the art that the present invention includes devices for performing one or more of the operations described in this application. These devices may be specially designed and manufactured for a desired purpose, or they may include known devices in general-purpose computers. These devices have computer programs stored therein, which are selectively activated or reconfigured. Such computer programs may be stored in a device-readable (e.g., computer-readable) medium or may be stored in any type of medium suitable for storing electronic instructions and respectively coupled to a bus. The computer-readable medium includes, but not limited to, any type of disk (including floppy disk, hard disk, optical disk, CDROM, and magneto-optical disk), ROM (Read-Only Memory), RAM (Random Access Memory), EPROM (Erasable Programmable Read-Only Memory), EEPROM (Electrically Erasable Programmable Read-Only Memory), flash memory, magnetic card or optical card. That is, a readable medium includes any medium that stores or transmits information in a readable form by a device (e.g., a computer).

It can be understood by those skilled in the art that each block in these structural diagrams and/or block diagrams and/or flowcharts and combinations of blocks in these structural diagrams and/or block diagrams and/or flowcharts may be implemented by computer program instructions. It can be understood by those skilled in the art that these computer program instructions can be provided to a processor of a general-purpose computer, a professional computer or other programmable data processing means for implementation, so that the schemes specified in the block or blocks of the structural diagrams and/or block diagrams and/or flowcharts disclosed by the present invention can be performed by the processor of the computer or other programmable data processing means.

Those skilled in the art can understand that the steps, actions and schemes in various operations, methods and processes discussed in the present invention may be alternated, changed, rearranged, decomposed, combined or deleted. In the case of similar technical solutions, the subject of execution and/or the specific implementation may be changed according to the scenario, and the scope of the change may be obtained by those skilled in the art based on the prior art and common knowledge.

The above is only part of the embodiments of the present invention, and it should be noted that for those of ordinary skill in the art, without departing from the principles of the present invention, several improvements and embellishments can be made, which should also be regarded as in the protection scope of the present invention.

1. A method performed by a first user equipment (UE) in a sidelink communication system, the method comprising:
generating first information associated with UE coordination related to sidelink communication;
generating second information indicating whether the first information associated with UE coordination is carried in a 2nd stage sidelink control information (SCI) format;
determining resources for the first information and the second information in a resource allocation mode 2; and
transmitting the first information and the second information to a second UE based on the determined resources.

2. The method of claim 1, wherein the first information is carried by the 2nd stage sidelink control information (SCI) format included in physical layer signaling.

3. The method of claim 1, wherein the resources are determined based on at least one of the following:
channel sensing;
resources configured or scheduled by a third UE except the first UE; and
a condition to generate and transmit the first information.

4. The method of claim 3, wherein the resources configured or scheduled by the third UE are determined based on at least one of the following:
resource pool-specific parameters related to the first information; and
parameters related to the first information determined based on a priority.

5. (canceled)

6. (canceled)

7. A method performed by a second user equipment (UE) in a sidelink communication system, the method comprising:
receiving, from a first UE, second information indicating whether first information associated with UE coordination is carried in a 2nd stage sidelink control information (SCI) format; and
receiving, from the first UE, the first information associated with UE coordination related to sidelink communication; and
determining whether a sidelink resource set including one or more sidelink resources indicated in the first information is available or not.

8-11. (canceled)

12. The method of claim 7, wherein in case that it is determined that the sidelink resource set including one or more sidelink resources indicated in the first information is unavailable, the method further comprises at least one of the following:
excluding unavailable sidelink resources among the one or more candidate sidelink resources; and
performing resource reselection.

13. (canceled)

14. A first user equipment (UE) in a sidelink communication system, the first UE comprising:
a transceiver; and
at least one processor configured to:
generate first information associated with UE coordination related to sidelink communication;
generate second information indicating whether the first information associated with UE coordination is carried in a 2nd stage sidelink control information (SCI) format;
determine resources for the first information and the second information in a resource allocation mode 2; and
transmit the first information and the second information to a second UE based on the determined resources.

15. A second user equipment (UE) in a sidelink communication system, the second UE comprising:
a transceiver; and
at least one a processor configured to:
receive, from a first UE, second information indicating whether first information associated with UE coordination is carried in a 2nd stage sidelink control information (SCI) format;
receive, from the first UE, the first information associated with UE coordination related to sidelink communication; and
determine whether a sidelink resource set including one or more sidelink resources indicated in the first information is available or not.

16. The method of claim 1, wherein the first information associated with UE coordination is carried by a medium access control (MAC) control element (CE) and the 2nd stage SCI format.

17. The method of claim 1, wherein the first information associated with UE coordination at least includes one or more candidate sidelink resources indicated by at least one of the following: time-frequency locations of the one or more candidate sidelink resources and bitmaps corresponding to the one or more candidate sidelink resources.

18. The method of claim 7, wherein determining whether the sidelink resource set including one or more sidelink resources indicated in the first information is available or not comprises:
determining whether a number of remaining available sidelink resources is in a specific interval;
in case that the number of remaining available sidelink resources are in the specific interval, determining that a candidate sidelink resource set including the one or more candidate sidelink resources is available; and
in case that the number of remaining available sidelink resources are not in the specific interval, determining that the candidate sidelink resource set including the one or more candidate sidelink resources is unavailable.

19. The method of claim 7,
wherein the first information associated with UE coordination is carried by the 2nd stage SCI format, or
wherein the first information associated with UE coordination is carried by a medium access control (MAC) control element (CE) and the 2nd stage SCI format.

20. The first UE of claim 14, wherein the first information associated with UE coordination is carried by the 2nd stage SCI format included in physical layer signaling.

21. The first UE of claim 14, wherein the resources are determined based on at least one of the following:
channel sensing;
resources configured or scheduled by a third UE except the first UE; and
a condition used to generate and transmit the first information.

22. The first UE of claim 21, wherein the resources configured or scheduled by the third UE are determined based on at least one of the following:
resource pool-specific parameters related to the first information; and
parameters related to the first information determined based on a priority.

23. The first UE of claim 14, wherein the first information associated with UE coordination is carried by a medium access control (MAC) control element (CE) and the 2nd stage SCI format.

24. The first UE of claim 14, wherein the first information associated with UE coordination at least includes one or more candidate sidelink resources indicated by at least one of the following: time-frequency locations of the one or more sidelink resources and bitmaps corresponding to the one or more sidelink resources.

25. The second UE of claim 15, wherein in case that it is determined that the sidelink resource set including one or more sidelink resources indicated in the first information is unavailable, the processor is further configured to perform at least one of the following:
exclude unavailable sidelink resources among the one or more sidelink resources; and
resource reselection.

26. The second UE of claim 15, wherein the processor is further configured to:
determine whether a number of remaining available sidelink resources is in a specific interval;
in case that the number of remaining available sidelink resources are in the specific interval, determine that a candidate sidelink resource set including the one or more sidelink resources is available; and
in case that the number of remaining available sidelink resources are not in the specific interval, determine that the candidate sidelink resource set including the one or more sidelink resources is unavailable.

27. The second UE of claim 15,
wherein the first information associated with UE coordination is carried by the 2nd stage SCI format included in physical layer signaling, or
wherein the first information associated with UE coordination is carried by a medium access control (MAC) control element (CE) and the 2nd stage SCI format.
